(19) United States
(12) Patent Application Publication
(10) Pub. No.: US 2005/0114095 A1
(43) Pub. Date: May 26, 2005

(54) Architectural building design system

(76) Inventor: Robert Guld, Akron, OH (US)

Correspondence Address: National IP Rights Center, LLC, Suite 400, 550 Township Line Road, Blue Bell, PA, 19422, US

(21) Appl. No.: 10/718,992

(22) Filed: Nov. 21, 2003

(51) Int. Cl. G06F 17/50

(52) U.S. Cl. 703/1

(57) ABSTRACT

A method for calculating an architectural criteria comprising the following steps: placing in a computer program, a series of parameters which are related to an architectural criterion; inputting a series of data such that the data input is compared to pre-stored programmatic criteria and outlines whether the architectural design meets the criteria

### FIELD OF THE INVENTION

The present invention is directed to the areas of architectural design. In particular, the present invention is directed to architectural design systems which set forth design and space requirements and which indicate whether these requirements are compatible with local or national building code requirements.

### BACKGROUND

The present invention is directed to architectural software and specifically to software and systems which assist designers in meeting building code parameters. There have long been different building codes across the United States, which have varied from state to state.

Over the past years, the code authorities have been trying to standardize and unify the basic building codes. This is being achieved by the adoption of the “International Building Code.” Each state or jurisdiction still has its own building code, but now most of them are based upon the “International Building Code.” Currently, forty-five (45) states use this code as their basis for determining building, space, occupancy and usage requirements.

When designing buildings and structures, designers, architects and engineers are required to put standard, pertinent information on the drawings for review and approval by the building authorities. Among this information are the calculated maximum allowable area and height, number of occupants, and required wall rating between different occupancies. Heretofore, this has been a fairly cumbersome task.

The patent literature contains prior art which related to related architectural design issues such as those required by the International Building Code. U.S. Pat. No. 6,516,451 is directed to a computer process used to create a report which checks a proposed project to insure conformity with existing standards. The software used utilizes a diagrammatic design program which allows creation of a model while checking compliance with the standard used in the proposed project. In the preferred embodiment example given, the method would first create a new project or open an existing project. Thereafter, the user would select a list of modules from rules algorithms for standards relating to the created or opened existing project. Next, the project would be designed by adding component parts and modifying their properties while maintaining compliance with the selected standards. Finally, a report, whether checklists, graphical layouts with dimensions or worksheets that enable the user to create a dimensioned graphical layout, would be created to demonstrate compliance with the selected standard. The screen displayed components and the standards are modularized to allow changing of both to suit a particular need. In the example program given electrical system manger (ESM), the selected project related to the electrical building industry and the standard used the current National Electrical Code.

While the above system assists architects and designers in meeting code requirements, it provides a complex methodology which is part and parcel of the design process. The patent does not track or suggest a simple and easy to implement system. The system disclosed in this patent is not portable and cannot be easily implemented in a stand alone system.

Heretofore there has not been a system which quickly and easily permits architects to determine the unit's space and occupancy requirements.

It would be desirable to provide a system which can be used to calculate architectural parameters and which can be easily calculated.

It is a principal purpose of the present invention to provide a system for easily calculating architectural parameters and which can easily determine them.

These and other objects of the present invention will be apparent from the detailed description which follows.

### SUMMARY OF THE INVENTION

In accordance with the present invention, a method and apparatus for calculating and determining a plurality of architectural design parameters from a variety of inputs. In a most preferred embodiment, the invention is a method for calculating a required architectural parameter.

In another embodiment, the invention is a method for calculating an architectural criteria comprising the following: placing in a computer program, a series of parameters which are related to an architectural criterion; inputting a series of data such that the data input is compared to prestored programmatic criteria and outlines whether the architectural design meets the criteria.

In a further embodiment, the pre-stored data may comprise height and area data, occupancy limitations and adjacent occupancy requirements.

These and other objects of the present invention will become apparent from the detailed description which follows

### BRIEF DESCRIPTION OF THE FIGURES

FIG. 1 is a block diagram of the present invention.

FIGS. 2 to 5 illustrate user screens for use in accordance with the present invention.

FIG. 6 is a representation of a hand held unit for use in the present invention.

### DETAILED DESCRIPTION OF THE INVENTION

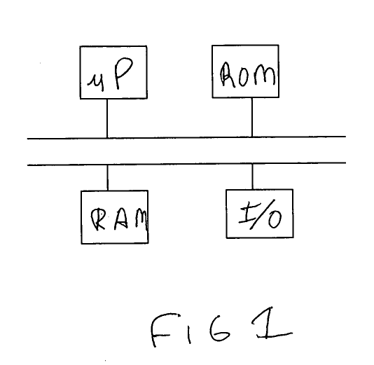

The present invention is shown and described with reference to the enclosed figures wherein the same number are utilized where applicable. Referring to FIG. 1, a system in accordance with the present invention is shown. As shown the system may comprise a simplified computerized system comprising a microprocessor 10, ROM 12, Ram 14 and I/O device 16. In one embodiment the ROM 12 stores programs for use in the present invention. In one embodiment, the invention can be accessed and utilized on the Internet.

The system of the present invention performs a number of functions. First, the system stores an algorithm to calculate the allowable area and height of a building. It also stores a program which calculates the allowable number of occupants, and required occupancy separation in a building, as further described below.

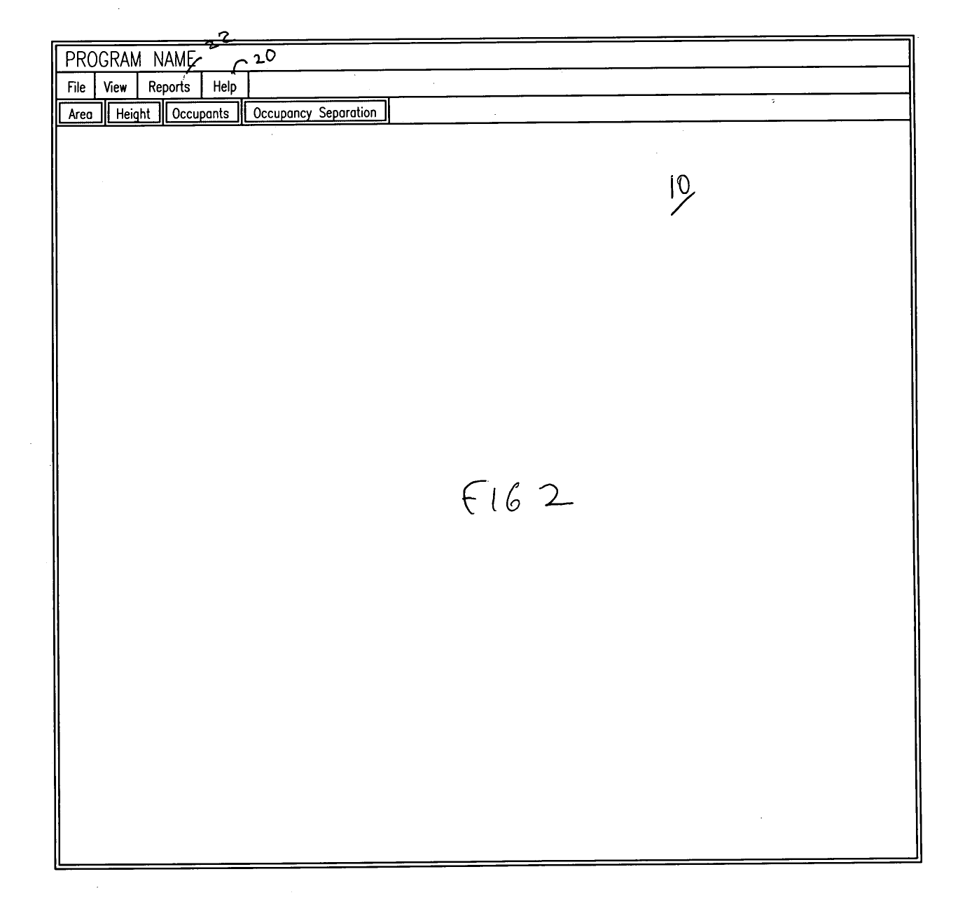

Referring to FIGS. 2 to 5, the basic program, in a typical environment, may be presented and used within a graphical user interface environment 10. In such an environment, the system could contain the standard “File,” “View,” and “Help” 20 menus along with a “Reports” menu 22 which would create a report of the calculations selected 24. The invention incorporates a number of algorithmic functions which perform a number of calculations.

The system in one embodiment is be set up as a simple desktop aid or as a program to be incorporated into existing software (i.e. AutoCAD). The database of the program would be based on the current “International Building Code” and would be configured to produce a series of calculations based upon an input.

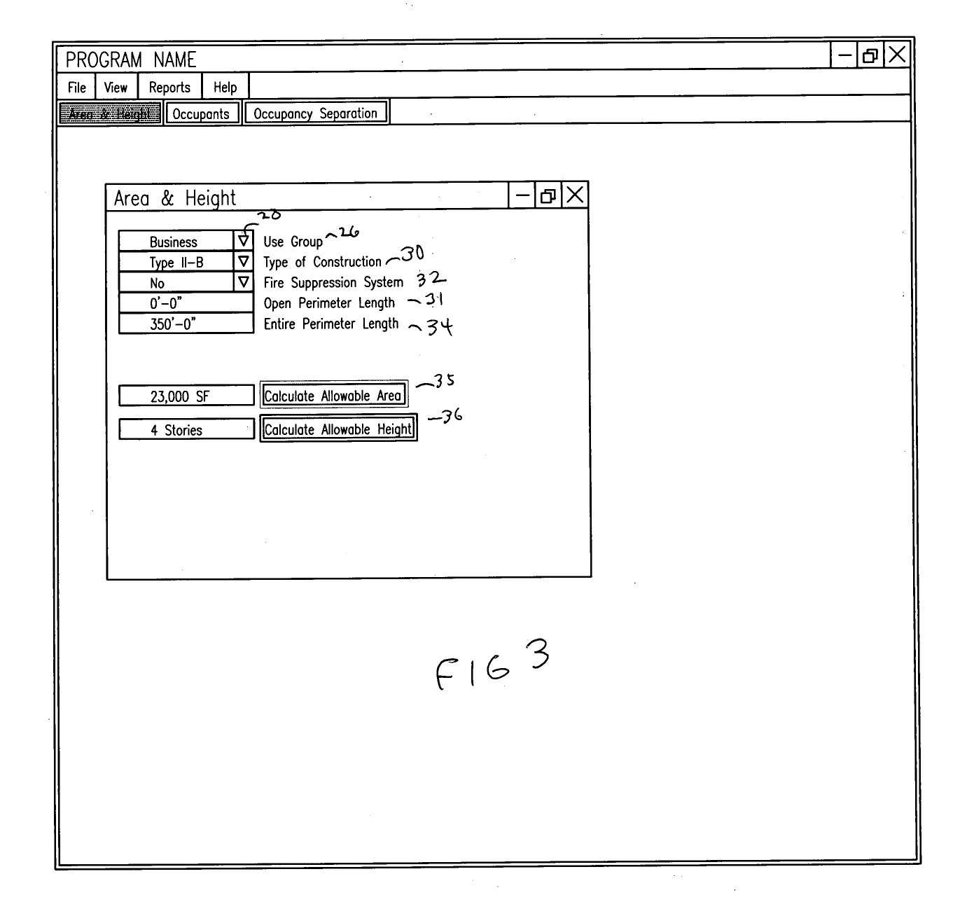

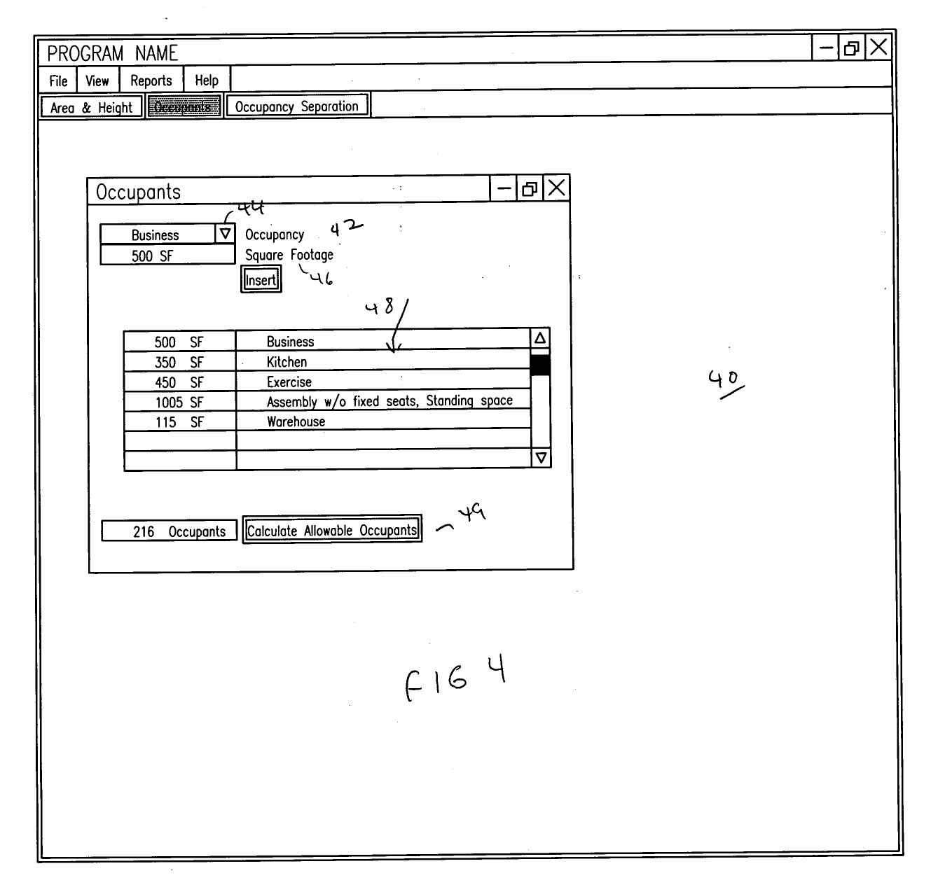

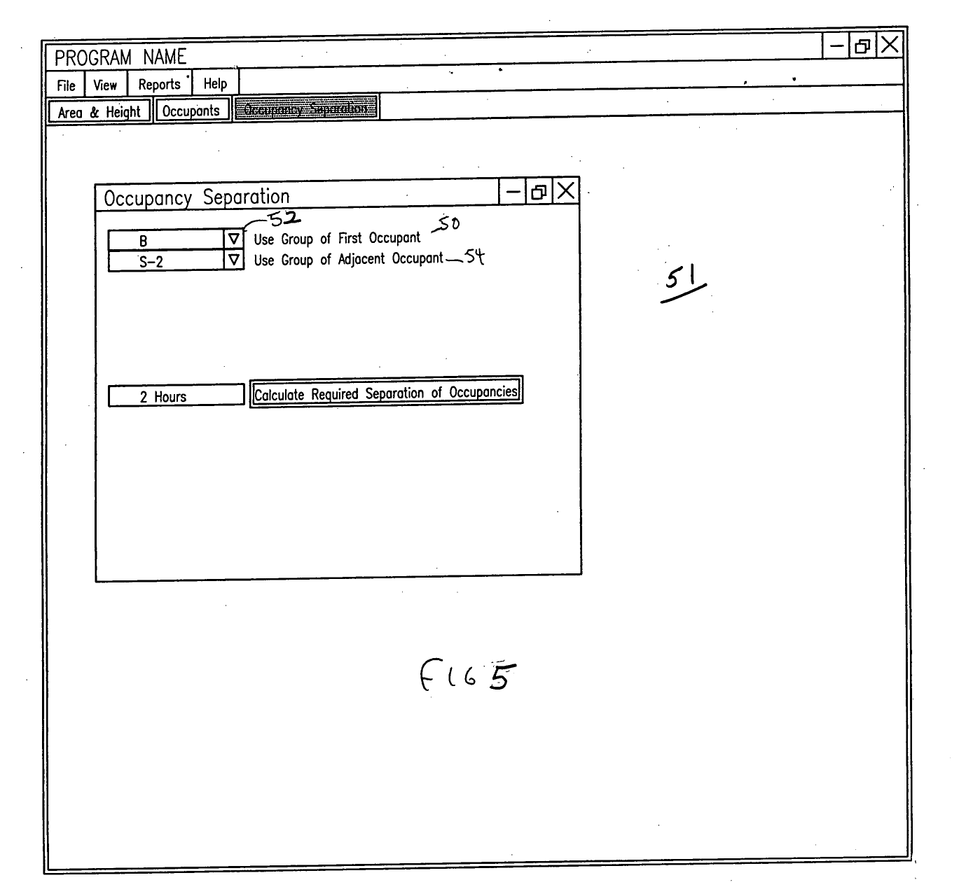

Examples of values and criteria the system might calculate include: allowable area and height (FIG. 3), the allowable number of occupants (FIG. 4), and required occupancy separation (FIG. 5), as further described below.

The first part of the program would calculate the size (square foot area and number of stories) a proposed building is allowed to be. The user would select a “Use Group” 26 from a pull down menu containing appropriate choices 28. Next, the user would select a “Type of Construction” 30 from a pull down menu containing appropriate choices.

The user would then select either “Yes” or “No” 32 from the pull down menu for the “Fire Suppression System.” Next, the user would enter the “Open Perimeter Length” in units of feet and inches 31. The final input from the user, would be the “Entire Perimeter Length,” 34 also in units of feet and inches. The user would then select the “Calculate Allowable Area” 35 and/or “Calculate Allowable Height” 36 to calculate the needed information based on the input. The calculations are based upon pre-stored data related to the Industrial Building Code.

This Module 40 of the program calculates the allowable number of occupants based on the size and occupancy type of the areas in view of the International Building Code requirements. In this module 40, the user would first enter the “Occupancy” 42 from a pre-selected list in the pull down menu 44. Next, the user would enter the square footage of that occupancy's area 46. An insert key would then be struck to add this information to a list, for calculation by the pre-stored program. Any number of areas and occupancy types (business, kitchen, etc.) could be added (or deleted) 48. When the list is complete, the user would strike the “Calculate Allowable Occupants” 49 for a calculation of the allowable number of occupants for that project based upon a number of pre-stored rules in the ROM 12 taken from the International Building Code.

A further module 51 of the system could calculate the required wall separation rating between different occupancies. In this module 51, the user would select the “Use Group of First Occupant” 50 from a pre-selected list in the pull down menu 52. Next, the user would select the “Use Group of Adjacent Occupant” 54 from a pre-selected list in the pull down menu. The final step is to depress the “Calculate Required Separation of Occupancies” feature to acquire the required separation rating. These values are maintained ROM 12 from the International Building Code and would facilitate the calculation.

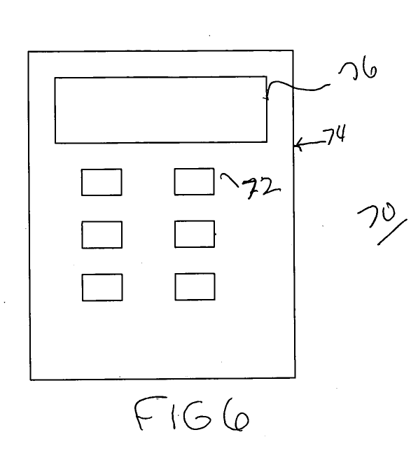

It is to be appreciated that the present invention can be used as a stand alone application and tool. Referring to FIG. 6, the invention may comprise a hand held system 70 which can be carried by an architect or designer and which could comprise software in a PDA. The tool will have a plurality of buttons 72 and a stored program 74 and an LCD display 76. The buttons facilitate the entry of various information related to occupancy and adjacent space.

These and other objects of the present invention will become apparent from the claims which are attached hereto. It is to be appreciated that the full nature and scope of the present intention is to be determined with reference to the claims appended hereto.

1. A method for calculating an architectural criteria comprising the following steps:
placing in a computer program, a series of parameters which are related to an architectural criterion; and
inputting a series of data relating to a building design such that the data input is compared to pre-stored parameters and which determines whether the building design meets the architectural criterion.

2. The method of claim 1 wherein the parameter comprises an occupancy limitation.

3. The method of claim 1 wherein said criterion is related to the possible area and height of the building.

4. The method of claim 1 wherein said criterion relates to the required wall separation rating between different occupancies.

5. A method for calculating an architectural criteria for a building comprising the following steps:
storing in a computer program, a series of building parameters which are related to architectural criteria;
inputting a series of data from a project related to the building parameters such that the data input is compared to the criteria and which determines whether the building parameters meet the criteria;
providing an output indicative of whether the criteria are met or are not met.
